(19) United States
(12) Patent Application Publication
(10) Pub. No.: US 2018/0032537 A1
(43) Pub. Date: Feb. 1, 2018

(54) File saving on geolocated polygons

(71) Applicants: Michael Foley, Los Angeles, CA (US); Edmond Richards, Los Angeles, CA (US)

(72) Inventors: Michael Foley, Los Angeles, CA (US); Edmond Richards, Los Angeles, CA (US)

(73) Assignee: Lagonal, Inc., Los Angeles, CA (US)

(21) Appl. No.: 15/731,762

(22) Filed: Jul. 28, 2017

Related U.S. Application Data
(60) Provisional application No. 62/368,158, filed on Jul. 28, 2016.

(51) Int. Cl. G06F 17/30; G01C 21/36; G01C 21/32

(52) U.S. Cl. CPC G06F 17/30091; G01C 21/32; G01C 21/3673; G06F 17/30241; G06F 17/30174; G06F 17/301

(57) ABSTRACT

A method comprising syncing, by a platform implemented by one or more processors, a plurality of computer files within an existing client data repository on a server to a specified geolocated polygons on a digital mapping interface, wherein the plurality of computer files are at least one of standalone computer files or computer files in a plurality of file directories; utilizing, by the platform, a geolocated polygon and attribute recommendation tool such that multiple embedded engines including (i) file directory and computer file property parsing to generate address or building name query strings to be processed through a machine learning gazetteer system; and (ii) optical character recognition to locate the address or building name query strings, to be processed through the machine learning gazetteer system, and keywords, processed into n-gram data structures to be cross-referenced against multiple internal or external keyword databases; and recommending, by the platform, geolocated polygons and geofile attributes, wherein all synced computer files are reviewed by a user and released to a geofile publication engine to be converted into a geofile and displayed on the digital mapping interface.

### CROSS-REFERENCE TO RELATED APPLICATIONS

The present application claims priority to U.S. Provisional Patent Application Ser. No. 62/368,158, filed on Jul. 28, 2016 entitled “File saving on geolocated polygons”, the disclosure of which is hereby incorporated in its entirety at least by reference.

### BACKGROUND OF THE INVENTION

### 1. Field of the Invention

The present invention relates generally to geolocated documents on a user interface of a client device, but more particularly to a system and method for file saving on geolocated polygons.

### 2. Description of Related Art

The medium for which individuals consume content is increasingly evolving with the phasing out of print medium and the introduction of the digital medium. There is a competitive landscape involved in this transformation and many changes will need to occur in order for the industry to adjust to the ever-changing demands of consumers and businesses.

Given the low cost to create digital content relative to other mediums like print or TV, digital content sphere is massive. Everyone from media conglomerates to college students upload millions of pieces of content across the globe every day. This content is either siloed across disparate web pages or among file directories on business servers or working its way down someone's social media feed into obscurity. This content is also difficult to track or find unless an individual is purposefully seeking it out on the specific web page where the content lives or using tools like Google or Lexis Nexus to find it.

There are many platforms in existence today using mapping technologies. Most common are companies like Esri, Google and Microsoft. These companies are focused primarily on creating data-driven mapping technology for consumers and enterprise that help with directions, traffic, transportation etc. In addition, there are companies that use mapping technology specifically targeting the real estate industry. Companies like CoStar, CoreLogic, Property Shark (Yardi), Real Capital Analytics, Zillow and Realtor.com focus on developers, investors and homebuyers and primarily deliver property analytics data like sales prices, property taxes, rental rates, occupancy etc. However, none of the companies in the market today use mapping technology to focus on aggregating geolocated content from many sources (e.g. newspapers, private enterprise, magazines, data providers etc.) to give a client the most comprehensive story of the buildings, neighborhoods and cities around us. Consequently, the present invention describes the process of geolocating aggregated content onto a digital interactive mapping interface.

### BRIEF SUMMARY OF THE INVENTION

In one embodiment of the present invention, a method is provided, comprising syncing, by a platform implemented by one or more processors, a plurality of computer files within an existing client data repository on a server to a specified geolocated polygons on a digital mapping interface, wherein the plurality of computer files are at least one of standalone computer files or computer files in a plurality of file directories; utilizing, by the platform, a geolocated polygon and attribute recommendation tool such that multiple embedded engines including (i) file directory and computer file property parsing to generate address or building name query strings to be processed through a machine learning gazetteer system; and (ii) optical character recognition to locate the address or building name query strings, to be processed through the machine learning gazetteer system, and keywords, processed into n-gram data structures to be cross-referenced against multiple internal or external keyword databases; and recommending, by the platform, geolocated polygons and computer file attributes, wherein all synced computer files are reviewed by a user and released to a geofile publication engine to be converted into a geofile and displayed on the digital mapping interface.

In one embodiment, the file directory and computer file property parsing engine is configured to search for at least one of addresses, building names, or keywords across file directory names and computer file names to be processed by the machine learning gazetteer system or processed into n-gram data structures. In another embodiment, the file directory and computer file property parsing engine consists of internal or external building name databases configured to be cross-referenced against potential building names parsed from file directory names or computer file properties to improve the accuracy of the corresponding geolocated polygon recommendations. In yet another embodiment, a location relationship processing engine is provided, wherein the location relationship processing engine utilizes optical character recognition cross-referenced against a database of naming conventions and keywords to establish relevant geospatial relationships of related content to recommend geolocated polygons and geofile attributes to the plurality of computer files.

In one embodiment, the optical character recognition engine processes content from the plurality of computer files to n-gram data structures to be cross-referenced against internal or external keyword databases to provide geofile attribute recommendations to the plurality of computer files. In one embodiment, the n-gram structured data processed by the optical character recognition engine can also be stored in the digital mapping interface to be retrieved by the geofile processing engine at any time in order establish geographic and thematic relationships between a plurality of geofiles on the digital mapping interface. In another embodiment, a step of creating an array of geofiles from the plurality of geofiles from different geolocated polygons that share geographic and thematic relationships is provided, wherein the array of geofiles is published to a common storyboard. In one embodiment, the file directories are configured to be migrated to the geolocated polygon and attribute recommendation tool in order to expedite the geolocated polygon recommendation process. In yet another embodiment, a recommendation methodology exists when the plurality of computer files are allocated to file directories ordered by geolocated polygons, wherein the geolocated polygon and attribute recommendation tool is configured to make a universal geolocated polygon recommendation to the plurality of computer files within a specific file directory of the file directories.

In one embodiment, the machine learning gazetteer system is configured to use previous matching experience to recommend a geolocated polygon based on parsed file directory names and computer file properties as well as optical character recognition techniques such that the syncing is more accurate and expedited. In one embodiment, a step of the user manually reviewing recommendations from the geolocated polygon and attribute recommendation tool to ensure accuracy prior to releasing a computer file or file directory of a plurality of computer files to the geofile publication engine to be converted to at least one geofile is provided, wherein the at least one geofile is displayed on the digital mapping interface. In another embodiment, a step of the user manually adding a geographic location to each of the plurality of computer files if the geolocated polygon and attribute recommendation engine is unable provide recommendations or an accurate recommendation is provided, as it relates to each of a plurality of computer files' corresponding geolocated polygon. In one embodiment, the geolocated polygon comprises a plurality of types including an individual property parcel, a neighborhood, or a city, and wherein the geolocated polygon and attribute recommendation engine may provide a geolocated polygon recommendation of a computer file that may include all of the plurality of types, none of the plurality of types, or any other combination thereof.

In another aspect of the invention, a method is provided, comprising steps (a) selecting a geolocated polygon on a mapping interface; (b) creating at least one geofile by uploading at least one computer file via a geofile creation tool on the geolocated polygon viewer, wherein the at least one file has defined attributes; (c) sending the at least one geofile to a geofile publication module; and (d) displaying the at least one geofile on the mapping interface.

In one embodiment, in step (a), the geolocated polygon types include an individual property parcel, a neighborhood and a city. In one embodiment, in step (b), the defined attributes include, but are not limited to, location, publish date, document file type, and a tag criteria. In another embodiment, a step of recommending a geolocated polygon based on the at least one file is provided, wherein the recommendation is processed through a geolocated polygon and attribute recommendation tool, wherein the geolocated polygon and attribute recommendation tool uses an optical character recognition processing engine, a locational relationship processing engine, and a file directory and computer file property parsing engine.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 is a network diagram depicting a mapping application having a client-server architecture configured for exchanging data over a network according to an embodiment of the present invention.

FIG. 2 shows a block diagram illustrating one example of a mapping system according to an embodiment of the present invention.

FIG. 3 shows a flow diagram illustrating of a geofile processing engine according to an embodiment of the present invention.

FIG. 4 shows a block diagram illustrating a content uploader according to an embodiment of the present invention.

FIG. 5 shows one example of a geolocated polygon and attribute recommendation tool processing a computer file from a client data repository to recommend one or more geolocated polygons and corresponding attributes to a client according to an embodiment of the present invention.

FIG. 6A shows one example of a geofile creation tool sending data to a geofile publication module according to an embodiment of the present invention.

FIG. 6B shows a digital map viewport viewable by users according to an embodiment of the present invention.

FIG. 6C is an example of a user address search utilizing a gazetteer system and returning a corresponding geolocated polygon on the digital map viewport according to an embodiment of the present invention.

FIG. 6D is an example of a geolocated polygon model which contains a geofile according to an embodiment of the present invention.

FIG. 7 shows an interaction diagram illustrating one example of an operation of a geofile publication module and a geofile processing engine according to an embodiment of the present invention.

FIG. 8 is a flow diagram illustrating a mapping system geofile creation handler according to an embodiment of the present invention.

FIG. 9 shows a diagrammatic representation of an exemplary machine or computer system configured to execute a set of instructions to perform any one or more of the methodologies discussed herein.

FIG. 10 is a block diagram illustrating a mobile device according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a method of computer file saving on geolocated polygons. The present invention describes the process of geolocating aggregated content onto geolocated polygons on a digital interactive mapping interface. Saving content to a mapping interface enhances its discoverability and geographic relational ties, thereby improving a user's understanding of a place with stories across time, topics and a geographic space.

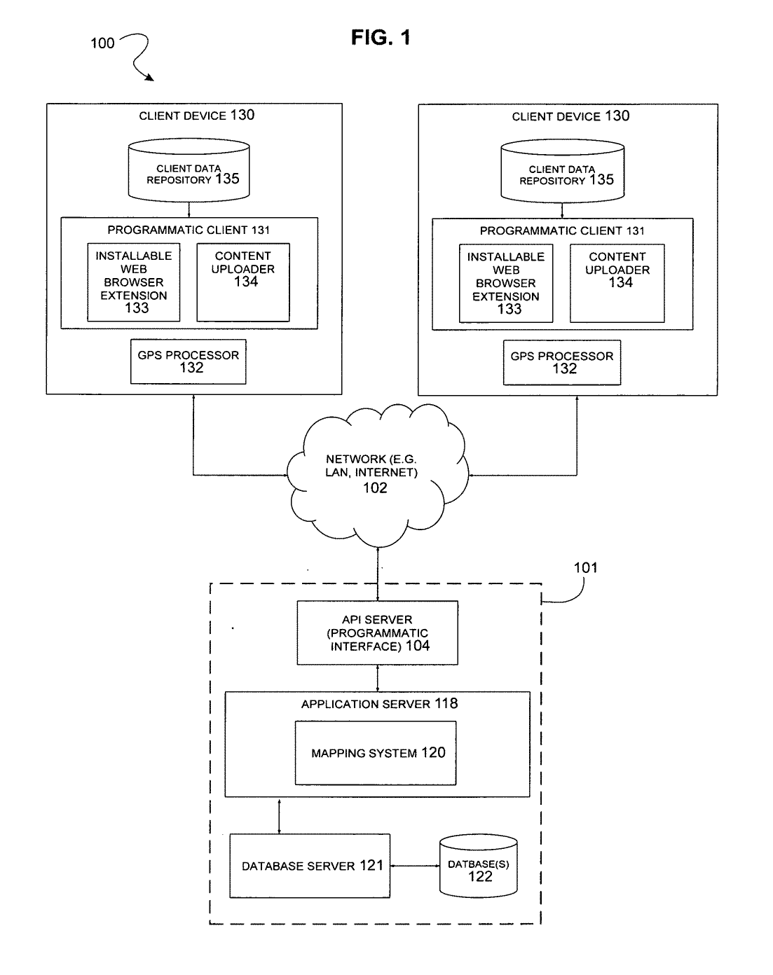

FIG. 1 is a network diagram depicting a mapping application 100 having a client-server architecture configured for exchanging data over a network 102 (e.g. the internet, LAN), according to an embodiment of the present invention. Referring now to FIG. 1, the client device (computer, mobile smart phone etc.) is equipped with a programmatic client 131 (e.g. mobile application, web application, etc) and a GPS processor 132 that provides the geographic coordinates of the client device to the mapping application 100. The client device uses the network to connect to a mapping application infrastructure 101. In one embodiment, the client device has access to a client data repository 135 that contains computer files. In one embodiment, the mapping application infrastructure includes an application programming interface (API) server (i.e. programmatic interface) 104 that interacts with the mapping application's application server 118 that runs a mapping system 120 and connects to a database 122, through a database server 121, with the client device over an interactive mapping interface.

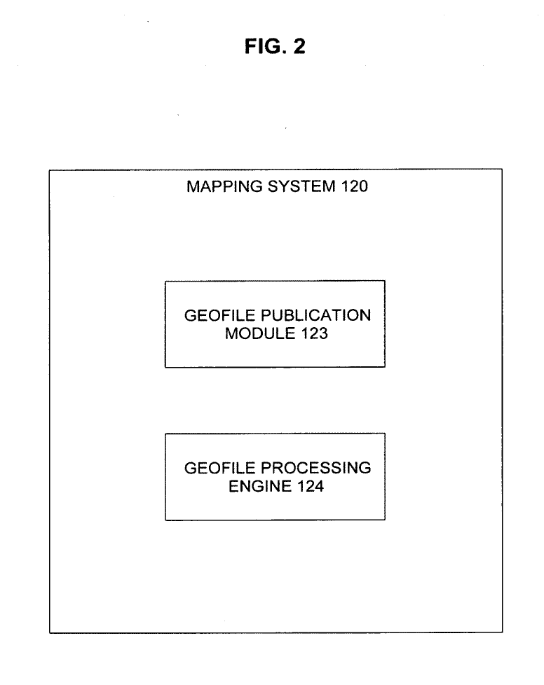

FIG. 2 shows a block diagram illustrating one example of mapping system 120 according to an embodiment of the present invention. Referring now to FIG. 2, the mapping system includes a geofile publication module 123 configured to receive at least one file and a selected geolocated polygon to create a geofile. This process will be described in greater detail below. In one embodiment, a geofile processing engine 124 is configured to retrieve the set of geofiles based on a plurality of selected geolocated polygons on a digital map viewport, and to provide the set of geofiles to a client device.

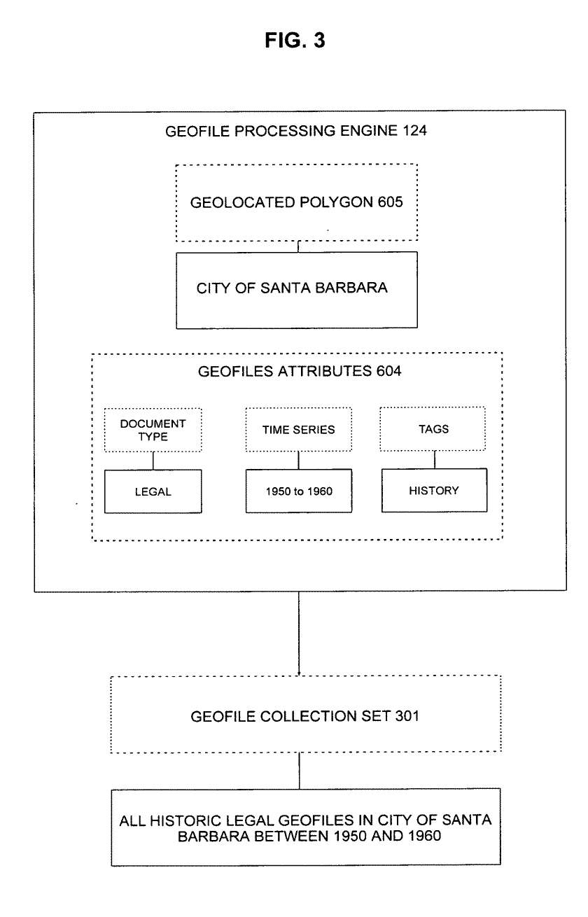

FIG. 3 shows a flow diagram illustrating of the geofile processing engine according to an embodiment of the present invention. Referring now to FIG. 3, the geofile processing engine is the sorting system for presenting geofiles 607 on the mapping system on a client device. In one embodiment, the sorting system filters by geofile attributes 604 which include, but are not limited to, location (e.g. address, neighborhood, city), publish (i.e. manifestation) date, document type (e.g. legal, financial, article), and tags (e.g. real estate, design, history). In the exemplary example, a selected geolocated polygon 605 of the City of Santa Barbara, having filtering criteria of a legal document, between the years 1950-1960 having a tag of history may return one or more geofiles that fall within the geolocated polygon and match the defined geofile attributes.

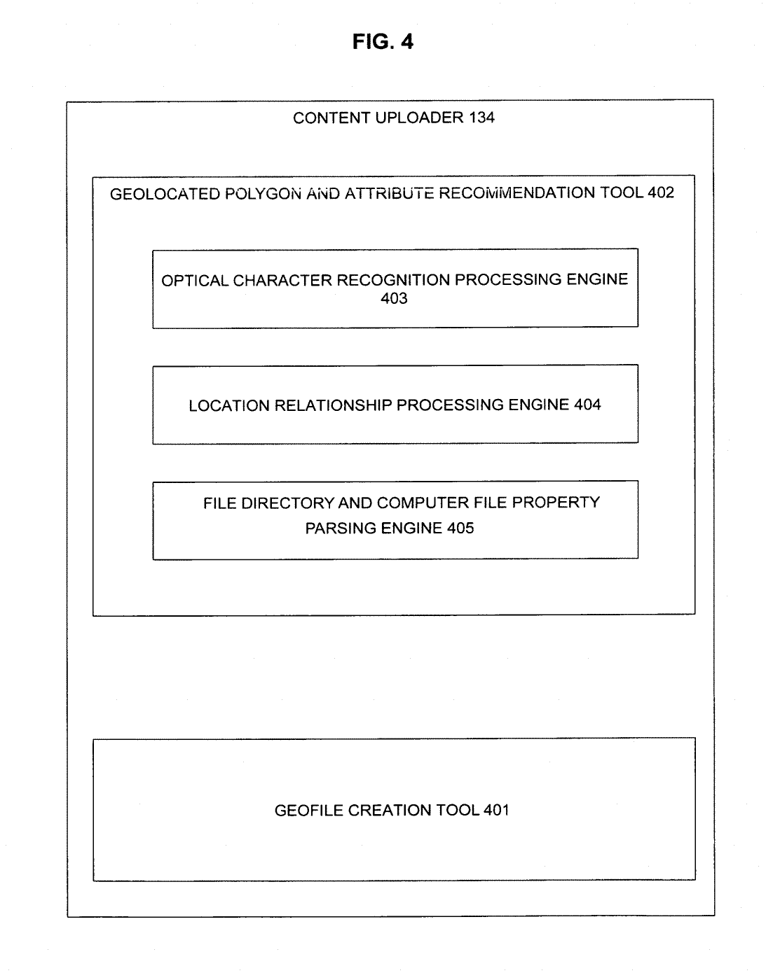

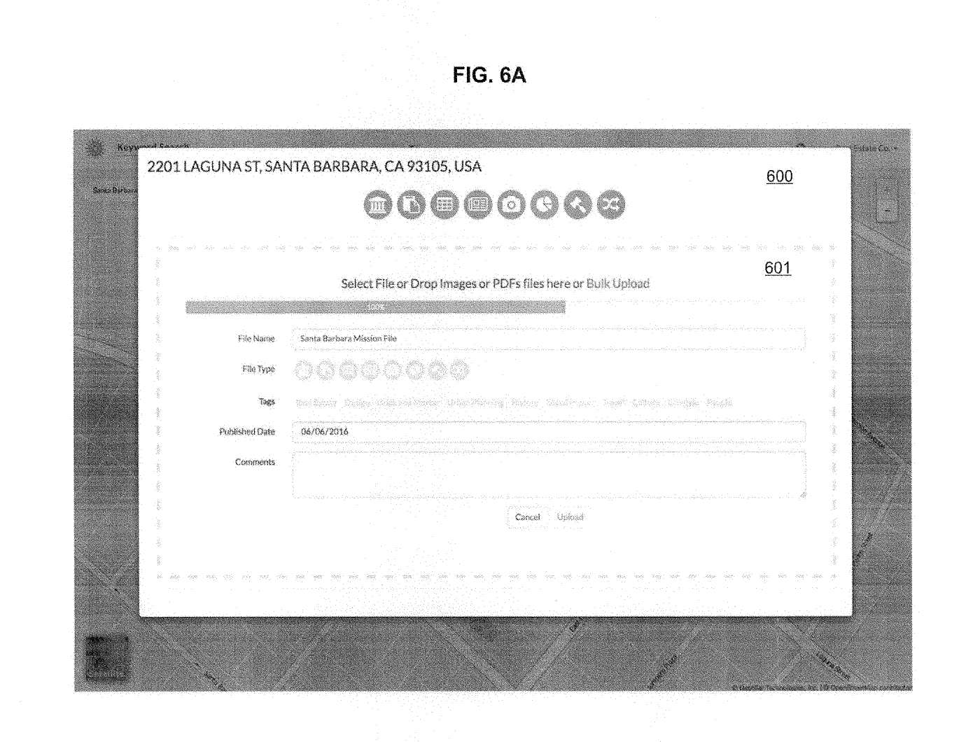

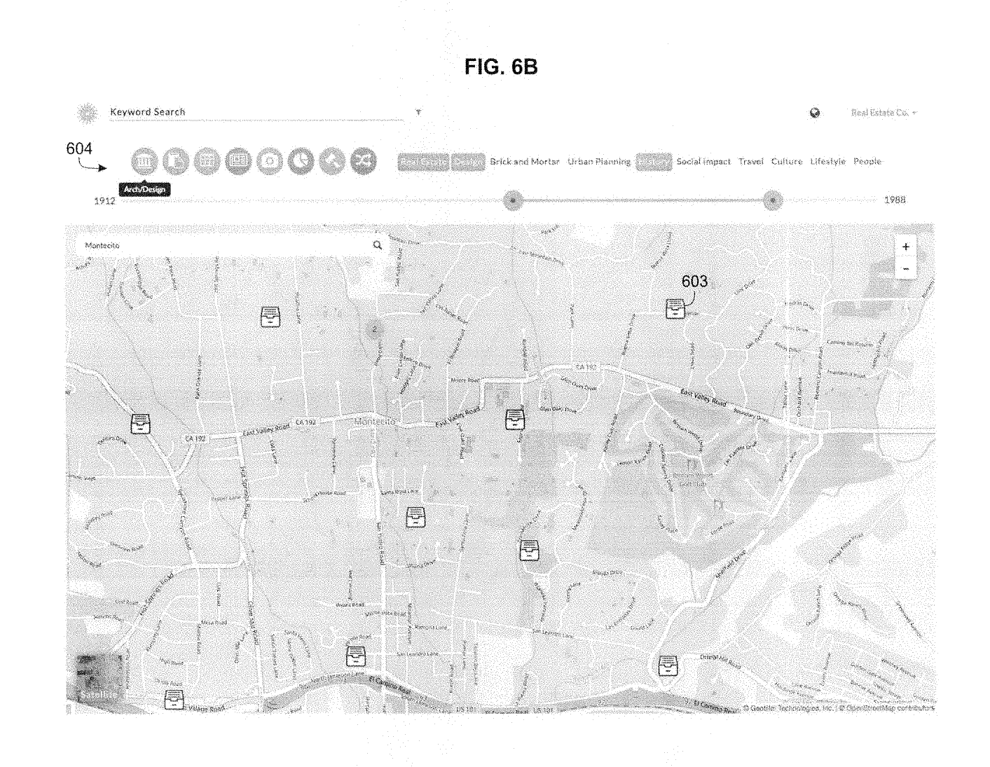

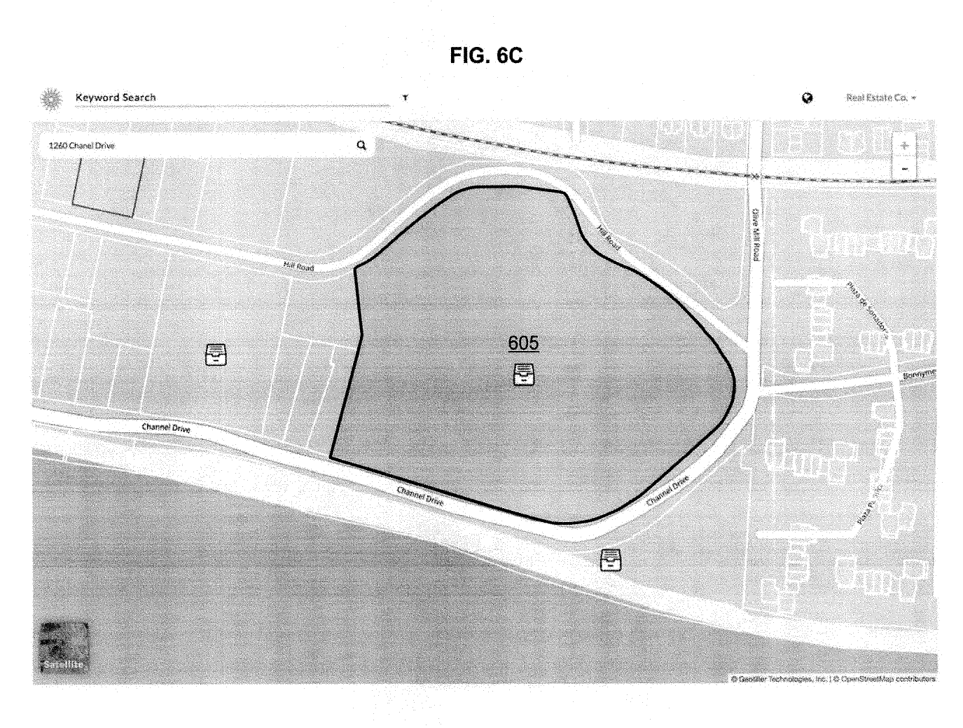

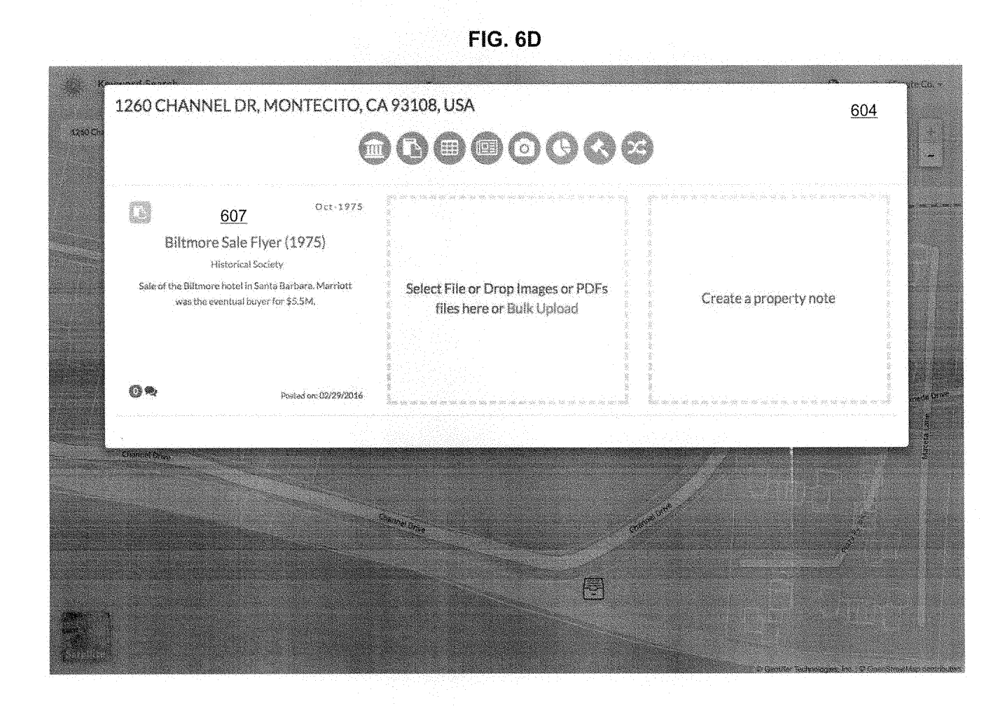

FIG. 4 shows a block diagram illustrating the content uploader 134 according to an embodiment of the present invention. Referring now to FIG. 4, the content uploader 134 consists of a geofile creation tool 401 and a geolocated polygon and attribute recommendation tool 402, where both tools are processes for a user to convert a computer file 501, or a large collection of computer files, to a geofile 607 (FIG. 6). In one embodiment, the geolocated polygon and attribute recommendation tool 402 uses a machine learning gazetteer system utilizing an optical character recognition processing engine 403, a locational relationships processing engine 404 and a file directory and computer file property parsing engine 405, to recommend to a user one or more geolocated polygons and attributes that correspond to the computer file(s).

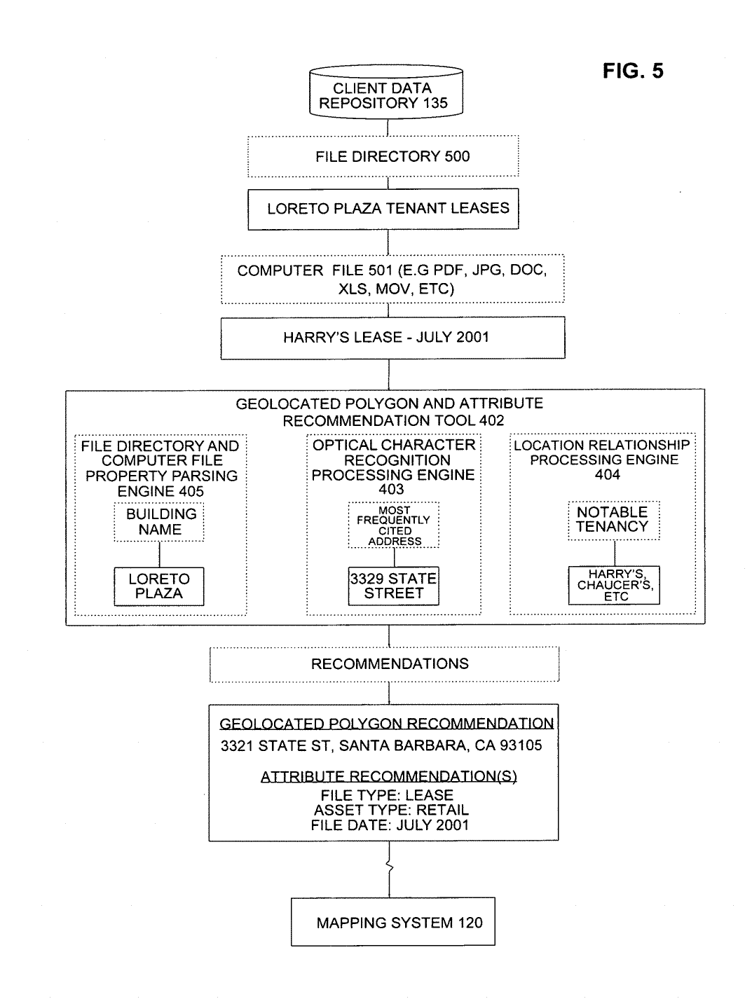

FIG. 5 shows an example of a geolocated polygon and the attribute recommendation tool processing a computer file 501 from a client data repository 135 to recommend one or more geolocated polygons and corresponding computer file attributes to the client according to an embodiment of the present invention. Referring now to FIG. 5, in one example, the geolocated polygon and attribute recommendation tool uses an optical character recognition processing engine 403, a locational relationships processing engine 404 and a file directory and computer file property parsing engine 405 to formulate (i) recommended query strings of all or portions of physical addresses or building names (e.g. Empire State Building) to a machine learning gazetteer system to locate corresponding geolocated polygons and (ii) recommended attributes based on attribute tables designed by either Geotiller or a Geotiller client. The geolocated polygon and attribute recommendation tool may be utilized for large sets of computer files, either standalone or in file directories, to rapidly expedite their conversion to geofiles using the geofile publication module 123 on the mapping system. In the exemplary example, a real estate brokerage (“PropCo”) has a large plurality of computer files 501 organized in a plurality of file directories 500 on its client data repository. PropCo's file directories and corresponding computer files are processed using the geolocated polygon and attribute recommendation tool to recommend matches of geolocated polygons to specific computer files. In one embodiment, a file directory name (e.g. Loreto Plaza Tenant Leases) and computer file properties (e.g. Harry's Lease—July 2001) are parsed (using the file directory and computer file property parsing engine) to determine either an address query string or a potential building name query string and cross-referenced against an internal or external database of naming conventions (consumed via a service hosted either remotely or locally) in order to search for a matching address using the machine learning gazetteer system and recommend one or more geolocated polygons for the file directory's corresponding computer files or the specific computer file. In another embodiment, content within each individual computer file (e.g. Harry's Lease—July 2001) in the file directory is processed into n-gram data structures by an optical character recognition processing engine to search for (i) addresses and frequency of addresses and (ii) keywords and keyword frequency to be cross-referenced against an internal or external keyword database (consumed via a service hosted either remotely or locally) to recommend one or more geolocated polygons and specific geofile attributes, as defined by either PropCo or Geotiller, for each computer file. The n-gram structured data can also be stored in the mapping application infrastructure 101 to be retrieved by the geofile processing engine 124 to find geographic and thematic relationships between geofiles on the mapping application. In another embodiment, a file directory's computer files (e.g. Harry's Lease—July 2001) contents are also processed through a Location Relationship Processing Engine which uses optical character recognition cross-referenced against an internal or external database of naming conventions and keywords (consumed via a service hosted either remotely or locally) to establish relevant geospatial relationships of related content to help recommend geolocated polygons and geofile attributes. PropCo then selects among the recommendations provided and sends the computer file to the geofile publication module to be converted to a geofile. Once these files are converted to geofiles on specified geolocated polygons with recommended attributes, the client will receive an attribute progress report that shows what percentage of the client's geofiles still require attributes. In one embodiment of the progress report, Geotiller offers a crowdsourced attribute module that incentivizes a client's users to fill in the remaining attributes on each geofile to maximize search functionality within Geotiller.

FIG. 6A shows one example of a geofile creation tool sending data to the geofile publication module according to an embodiment of the present invention. Referring now to FIG. 6A, a geolocated polygon viewer 600 is activated by selecting a particular geolocated polygon on the mapping system. In one embodiment, the geolocated polygon viewer includes a geofile creation tool 601 for uploading a computer file, or multiple computer files, with defined geofile attributes 604 (e.g. published date, document type, tags(s)) on the geolocated polygon to create a geofile. Once the geofile is created, it is viewable through the geofile processing engine on the mapping system. FIG. 6B shows a digital map viewport 602 viewable by a user or a plurality of users. All geolocated polygons that hold geofiles on the digital map viewport contain a data marker 603. FIG. 6C is an example of a user address or building name search utilizing a gazetteer system and returning a corresponding geolocated polygon 605 on the digital map viewport. FIG. 6D is an example of a geolocated polygon modal 606 which contains a geofile 607, (i.e. a geolocated computer file).

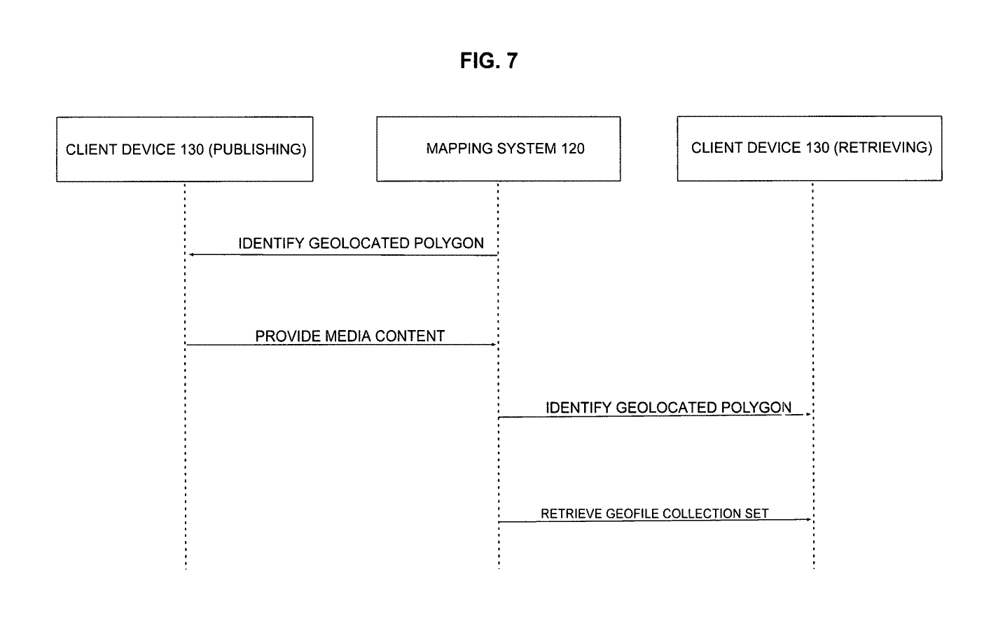

FIG. 7 shows an interaction diagram illustrating one example of an operation of the geofile publication module and the geofile processing engine according to an embodiment of the present invention. Referring to FIG. 7, a client device 130 (e.g. a computer, mobile phone) interfaces with the mapping system on the mapping application to identify a geolocated polygon to provide content to create a geofile. In another embodiment, the client device utilizes the mapping system on the mapping application to identify a geolocated polygon and receive a geofile collection set 806 that corresponds with the geolocated polygon. The geofile collection set will be described in greater detail below.

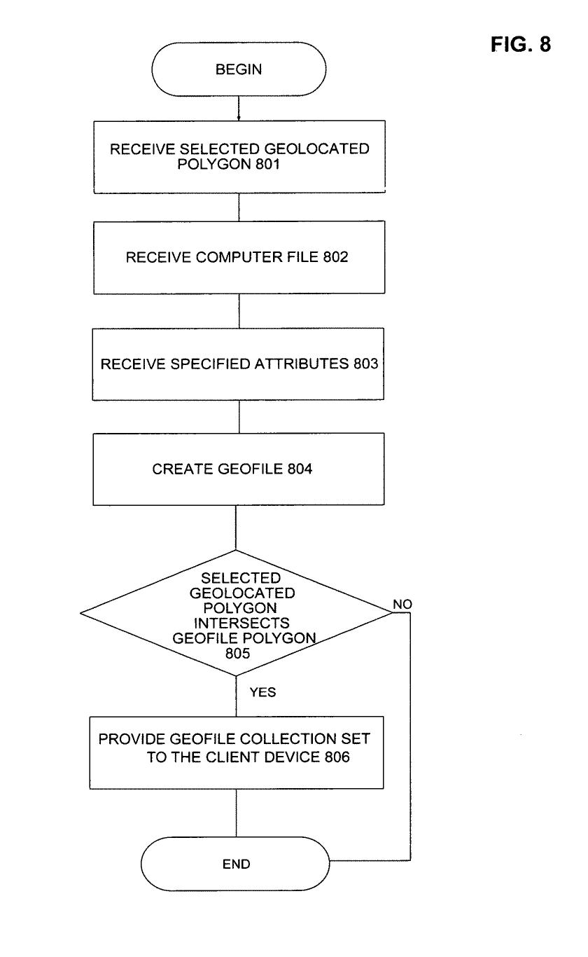

FIG. 8 is a flow diagram illustrating the mapping system geofile creation handler according to an embodiment of the present invention. Referring now to FIG. 8, in one embodiment, the geofile handler may receive a selected geolocated polygon 801 (a plane figure bounded by geospatial coordinates 605; FIG. 6C), receive a file 802 (e.g. computer files like PDFs, Microsoft Word documents, Argus files etc.) and receive a set of specified geofile attributes 803 (e.g. published date, document type, tags(s)) in any particular order. Once each of these receipts have been confirmed, the geofile creation handler will write a geofile 804 (a geolocated computer file), to the mapping system. In one embodiment, the geofile creation handler in turn will respond with a geofile collection set 806 of geofiles that intersect the selected geofile polygon 805 associated with the newly created geofile. The geofile handler will return geofiles to the client device only if the geolocated polygon associated with the newly created geofile intersects with the retrieved geofile's geolocated polygon. In another embodiment, the geofiles returned may be those that have geolocated polygons intersecting with the current map viewport on the client device.

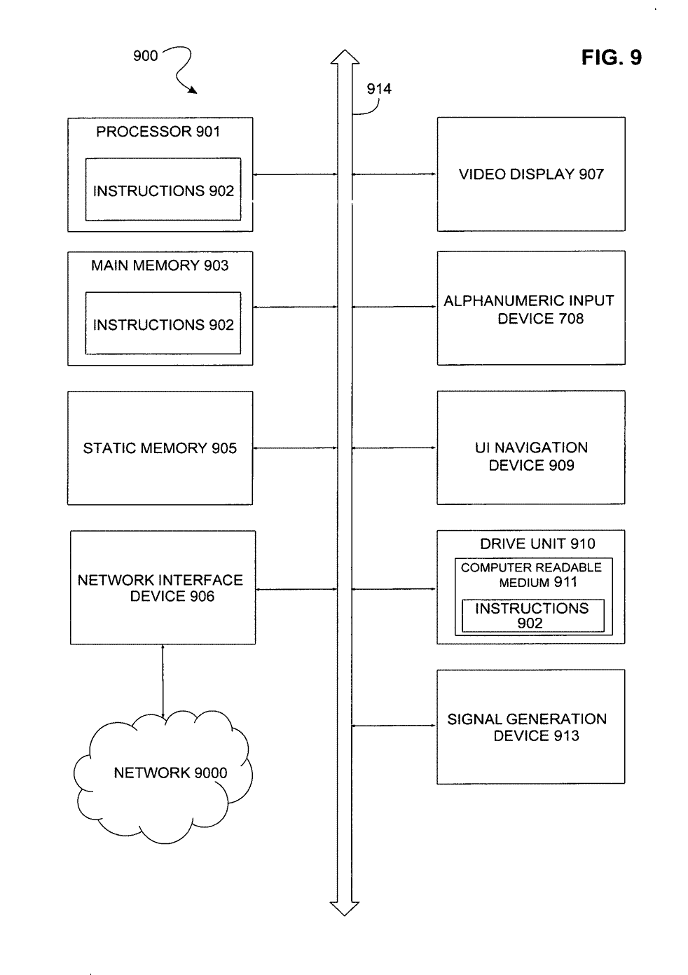

FIG. 9 shows a diagrammatic representation of a machine in the example form of a machine or computer system 900 within which a set of instructions 902 may be executed causing the machine to perform any one or more of the methodologies discussed herein. Referring now to FIG. 9, the machine or computer system may be a personal computer (PC), a tablet PC, a set-top box (STB), a personal digital assistant (PDA), a cellular telephone, a web appliance, a network router, switch or bridge, or any machine capable of executing a set of instructions 902 (sequential or otherwise) that specify actions to be taken by that machine. It should be understood that while only a single machine is illustrated, the term “machine” shall also be taken to include any collection of machines that individually or jointly execute a set (or multiple sets) of instructions. The example machine or computer system 900 includes a processor 901 (e.g. central processing unit (CPU), a graphics processing unit (GPU), or both), a main memory 903, a static memory 905, which communicate with either other via a bus 914. The computer system may further include a video display unit 907 (e.g. a liquid crystal display (LCD) or a cathode ray tube (CRT)). In one embodiment, the computer system also includes an alphanumeric input device 908 (e.g. a keyboard), a UI navigation device 909 (e.g. a mouse), a drive unit 901, a signal generation device 913 (e.g. a speaker), and a network interface device 906. The drive unit 910 includes a computer-readable medium 911 on which is stored one or more sets of data structures and instructions 902 (e.g. software) embodying or utilized by any one or more of the methodologies or functions described herein. In one embodiment, the instructions may also reside, completely or at least partially, within the main memory or within the processor during execution thereof by the computer system, with the main memory and the processor also constituting the machine-readable media. The instructions may further be transmitted or received over a network 9000 via the network interface device 906 utilizing any one of a number of well-known transfer protocols (e.g. HTTP). While the computer-readable medium is shown in an example embodiment to be a single medium, the term “computer-readable medium” should be taken to include a single medium or multiple media (e.g. a centralized or distributed database, and/or associated caches and servers) that store the one or more sets of instructions. The term “computer-readable medium” shall also be taken to include any medium that is capable of storing, encoding, or carrying a set of instructions for execution by the machine that cause the machine to perform any one or more of the methodologies of the present disclosure, or that is capable of storing, encoding, or carrying data structures utilized by or associated with such a set of instruction. The term “computer-readable medium” shall, accordingly, be taken to include, but not be limited to, solid-state memories, optical media, and magnetic media. Furthermore, the machine-readable medium is non-transitory in that it does not embody a propagating signal. However, labeling the tangible machine readable medium “non-transitory” should not be construed to mean that the medium is incapable of movement—the medium should be consider as being transportable from one physical location to another. Additionally, since the machine-readable medium is tangible, the medium may be considered to be a machine-readable device.

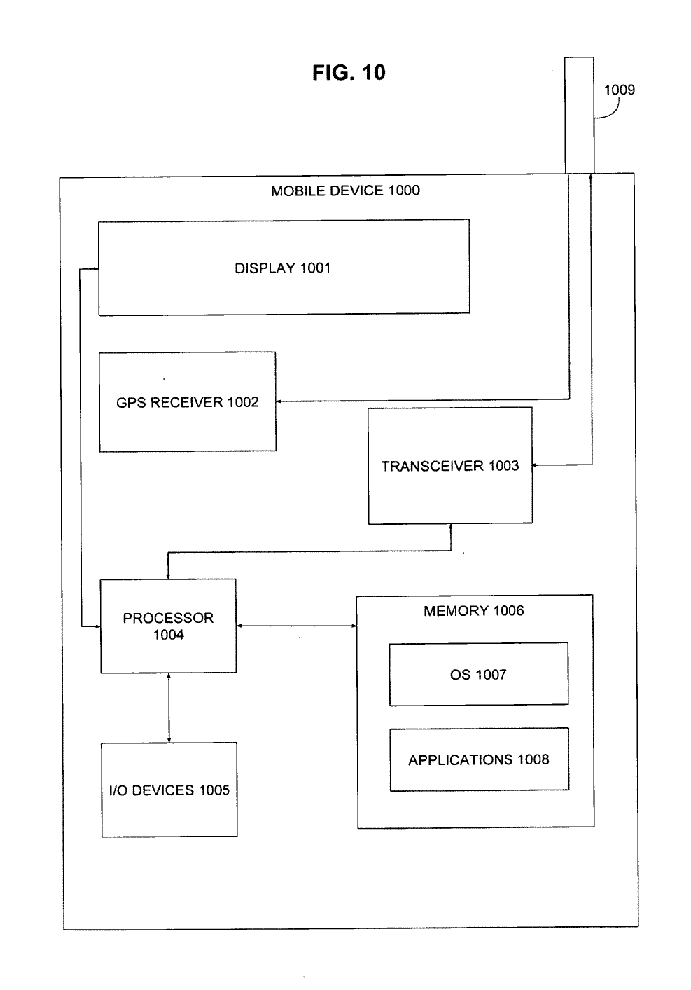

FIG. 10 is a block diagram illustrating a mobile device 1000, according to an embodiment of the present invention. Referring now to FIG. 10, the mobile device may include a processor 1004, wherein the processor may be any of a variety of different types of commercially available processors suitable for mobile devices (for example, an XScale architecture microprocessor, a microprocessor without interlocked pipeline stages (MIPS) architecture processor, or another type of processor). A memory 1006, such as a random access memory (RAM), a flash memory, or another type of memory, is typically accessible to the processor. In one embodiment, the memory may be adapted to store an operating system (OS) 1007, as well as applications 1008, such as a mobile location enabled application that may provide location-based services (LBSs) to a user. In one embodiment, the processor may be coupled either directly or via appropriate intermediary hardware, to a display 1001 and to the one or more input/output (I/O) devices 1005, such as a keypad, a touch panel sensor, a microphone, and the like. Similarly, in alternative embodiments, the processor may be couple to a transceiver 1003 that interfaces with an antenna 1009. In one embodiment, the transceiver may be configured to both transmit and receive cellular network signals, wireless data signals, or other types of signals via the antenna, depending on the nature of the mobile device. Further, in some configurations, a GPS receiver 1002 may also make use of the antenna to receive GPS signals.

### BEST MODE

Now referring to any of the accompanying figures, the intent of the present disclosure is to describe processes for creating, displaying and sharing files on geolocated polygons on an interactive digital mapping application, or a mapping application 100.

Digital mapping technology has become integral to our everyday lives. Yet with all the recent advancements, digital mapping has yet to help tell a more complete story of the buildings, neighborhoods and cities around us. With the addition of a multitude of files (e.g. articles, photos, videos, architectural drawings) to geolocated polygons on a mapping application 100, a user is given a more complete and vibrant understanding of a place. Herein these geolocated files are referred to as geofiles 607.

In one embodiment, a user creates a geofile 607, or multiple geofiles, by locating a geolocated polygon 605 (e.g. property, neighborhood, city) on the mapping application. Once the user selects the geolocated polygon, the mapping application will display the geolocated polygon's dialog box which includes a geofile creation tool 601 to enable the user to upload a computer file 501, or multiple computer files, with defined attributes (e.g. published date, document type, tags(s)) on the geolocated polygon. Upon submitting the computer file(s), a geofile(s) is created and sent to a geofile publication module 123 and published to a mapping system 120 to display on the mapping application. For example, a user may use the mapping application to locate the geolocated polygon for the Santa Barbara Mission. Selecting the Santa Barbara Mission's geolocated polygon will invoke the geolocated polygon's dialog box and geofile creation tool 601 to enable the user to create a geofile from the article dated Oct. 30, 1925 by the Santa Barbara News-Press reporting on how the mission was rebuilding after the 6.8 magnitude earthquake in the summer of 1925. The user uploads the file on the Santa Barbara Mission geolocated polygon and confirms certain attributes including that it's an “article,” it was originally published on Oct. 30, 1925 (published date) and tags it with themes like “history” and “design.” The geofile is created and sent to the geofile publication module and published to the mapping system to display on the mapping application.

Mapping application 100 comprises processes for creating geofiles that are determined by submitting a query string to a gazetteer system. In one embodiment, the mapping application allows the user to enter a query string related to a geographic location (e.g. address, point of interest) which the mapping system in turn submits to a gazetteer system. The gazetteer system returns a geolocated polygon 605 corresponding to the entered query string alongside other nearby polygons in the current map viewport of the client's device. The user can select the geolocated polygon on the mapping application to invoke the polygon's dialog box and geofile creation tool 601. The user creates a geofile 607, thereby sending the geofile to the geofile publication module and publishing the geofile to the mapping system to display on mapping application 100.

A geofile can be created by a user on a geolocated polygon through a digital content management module. In one embodiment, a user invokes a digital content management dialog box on the mapping application that provides a user with a web-based template for entering text, pictures and video. A user is also required to locate a geolocated polygon on which to create the geofile as part of this process. The process may include a previewing view as well as a content editing tool that other users can use to edit the geofiles contents. Once the geofile is created, it is sent to the geofile publication module to be published on the mapping system to display on the mapping application.

A geofile can be created by a user on a geolocated polygon 605 through a storyboard dialog box. A storyboard is designed to allow users to tie an array of geofiles 607 from different geolocated polygons to one common theme/topic. Geofiles can either be created through the storyboard dialog box or, if already existing, attached to a storyboard from their respective geolocated polygon dialog boxes. As an example, a user invokes an existing storyboard dialog box on the mapping application. The storyboard theme is “New Los Angeles Apartment Developments.” The user has an article from a local newspaper discussing a future apartment development in Westwood. The user uses this article to create a geofile on the storyboard dialog box. During geofile creation, the user locates a geolocated polygon by either (i) adding the address of the desired geolocated polygon to a gazetteer system and the gazetteer system thereby returning the address' corresponding geolocated polygon on which to create the geofile, or (ii) manually selecting the geolocated polygon on the mapping interface where the user wishes to create the geofile. Users may also add comments to the storyboard dialog box without adding a geofile. If a file is created in the storyboard dialog box, it is still visible in the viewport on the client's device and is labeled as being part of a particular storyboard.

In another embodiment, the mapping application comprises a process for concurrent display of geofiles. Geofiles are displayed on the mapping application using a data marker 603 on geolocated polygons within the current map viewport on the client's device. A single data marker is displayed on each geolocated polygon containing one or more geofiles. Clicking on a data marker will invoke the dialog box for the data marker's corresponding geolocated polygon. The geolocated polygon's dialog box will display the geofile creation tool and all the geofiles created on that particular geolocated polygon. A user can then select a specific geofile to view its contents.

In another embodiment, mapping application 100 comprises a process for the concurrent display of a geofile collection set 301 within the current map viewport on the client's device. The geofile collection set view lists the geofiles located in the current map viewport on the client's device using a stacked card deck design, either full screen or split screen with the mapping application that displays geofiles 607 in descending order, with the most recently created geofiles at the top. Each geofile is represented as an individual card on the geofile collection set view. All cards include a geofile title, upload date, author and geographic pin. Clicking on the geographic pin takes the user to the geofile's geolocated polygon 605 on the mapping application while clicking anywhere else on the card takes the user to the contents of the geofile. A geofile card may also include a geofile summary, a photo and a geofile publish (i.e. manifestation) date.

In one embodiment, a geofile created on a geolocated polygon is also stored in a content manager file system on the mapping application. The content manager file system is categorized by geofile type (e.g. article, legal, media) and is viewable by all users within the organization where the geofile is created. The creator of the geofile can also view, edit, hide and delete the geofile by accessing the geofile through the content manager file system.

Each geofile on the mapping application is viewable in a geofile content viewer. In one embodiment, the geofile content viewer opens within the mapping application and includes all attributes of the geofile as well as a list of content located within a set radius of the geofile being viewed geofile on the mapping application. The nearby content may be ranked for viewing based on a recommendation algorithm that uses information specified by the user as well as information generated on behalf of user behavior to recommend nearby content. Select geofiles also allow for additional comments from a subset of users on the mapping application.

In one embodiment, a geofile may be created with an installable web browser extension. The web browser extension is installed over the network 102 on a client device 130 web browser. The web browser extension may be utilized to capture web address urls (e.g. blogs, news website articles) to be sent to the mapping application infrastructure 101. The mapping application infrastructure parses the web address url and creates a computer file 501 saved into a processing queue of computer files awaiting to be added to the mapping application 100 through the geofile publication module 123. This queue may also be processed by the geolocated polygon and attribute recommendation tool 402 to make geolocated polygon and geofile attribute recommendations to be viewed by the client and to eventually be added to the mapping application through the geofile publication tool.

In one embodiment, a geofile, or a collection of geofiles, may be created using a content uploader that is installed on the client's device. The content uploader allows for the uploading of multiple files 502 to a geofile processing queue. The client will then specify the required geolocated polygon 501 (e.g. individual parcel, neighborhood, city) and content attributes (e.g. document type, publication date) and subsequently the geofile will be made available on the mapping application 100. The content uploader makes it easy for the user to quickly sift through the content attributes and make the required changes or additions to the content prior to it becoming a geofile on the mapping application. In one embodiment, the content uploader includes a machine learning system that parses the content data to recommend attributes as well as a geolocated polygon 501 to the user of the content uploader (the geolocated polygon and attribute recommendation tool 402). These recommendations expedite the uploading process by aiming to provide a portion of the computer file's attributes to the uploader as opposed to prior mentioned manual process.

In one embodiment, mapping application 100 also may include a machine learning system within a geofile processing engine 124 designed to find geographic and thematic relationships between geofiles on the mapping application. In one embodiment, a user can compare the contents of its geofiles as well as to that of all public geofiles the users is subscribed to on the mapping application. The geofile processing engine will then work to determine potential similarities as it relates to themes, dates, people and geographic location of geofiles on the mapping application. The geofile processing engine will then return potential storylines that the user's geofile might fall within amongst the other geofiles on the mapping application.

System Architecture

FIG. 1 is a network diagram depicting a mapping application 100 having a client-server architecture configured for the publishing and retrieval of media content over a network, according to one embodiment of the present invention. For example, the mapping application may be a media content platform where clients may publish and retrieve data within the mapping application. In one embodiment, the data may pertain to various functions (e.g. publishing and retrieving text and media communication, determining geolocation) and aspects (e.g. publication of media content) associated with the mapping application and its users. Although illustrated herein as client-server architecture, other embodiments may include other network architectures, such as peer-to-peer or distributed network environments.

In one embodiment, a media content platform includes a mapping system 120, and may provide server-side functionality via a network 102 (e.g. LAN, Internet) to one or more clients. The one or more clients may include users that utilize the mapping application and, more specifically, the mapping system, to publish and retrieve media content over the network. These operations may include publishing, retrieving, transmitting and processing media content to, from, and regarding media content and users of the mapping application. The data may include but is not limited to content and user data such as user profiles, computer files, media content binary data, media content metadata attributes, client device information, geolocation information, and live event data information, among others.

Mapping Application

FIG. 2 shows a block diagram illustrating one embodiment of mapping system 120. The mapping system may be hosted on a dedicated or shared server machines (not shown) that are communicatively coupled to enable communications between server machines. The mapping system 120 may access one or more databases 122 via the database server(s) 121 (FIG. 1).

In one embodiment, the mapping system is responsible for the generation and delivery of media content between users possessing a programmatic client 131. It is a particular advantage of the present invention, that each user possessing the programmatic client can freely exchange media content with other users within their organization.

In one embodiment, the mapping system includes a geofile publication module 123 and a geofile processing engine 124. As previously mentioned, the geofile publication module is configured to receive at least one file and a selected geolocated polygon to create a geofile. The geofile processing engine is configured to retrieve the set of geofiles based on a selected geolocated polygon, and to provide the set of geofiles to the client device.

FIG. 3 shows a flow diagram illustrating one embodiment of geofile processing engine 124, wherein the client device geolocation is used to create the geolocated polygon required to retrieve the set of geofiles from the geofile processing engine. In one embodiment, each geofile possesses certain attributes of which can be individually requested using parameters sent to the geofile processing engine and thereby returning a set of geofiles that meet the individually requested requirements. A geofile attribute is a set of name/value pairs within the mapping application that enable enhanced content discovery. In one embodiment, geofile attributes can include parameters like computer file theme (article, multimedia, legal), publish (i.e. manifestation) date (a time series search) and content tags (e.g. real estate, brick & mortar, lifestyle).

In one embodiment, users on the mapping application belong to an organization. There is no limit to the number of users within an organization and an organization can be as small as a single user. Organizations have permissions whereby geofiles are either public or private. Public geofiles are created in an organization with public permissions, allowing public geofiles to be viewed, either for free or with paid subscription, by all other organizations on the platform. The mapping application provides a list of public organizations that users may subscribe to in order to view their public geofiles. Public organizations′create a publishing window(s) within their organization to publish geofiles. The publishing windows allow public organizations to better curate their content experience around topics, markets, themes or subscription price points. A private geofile can be created by organizations with both public and private permissions but is only viewable by users within the organization where it was created. No organization can subscribe to an organization with only private permissions. A user can belong to more than one organization and both a public and private organization.

In one embodiment, to control the number of geofiles displayed on the mapping application, users have the ability to mute public organizations' publishing windows as well as users within their organizations, including themselves. When a publishing window or a user is muted, the geofile processing engine masks the geofiles created by these entities from displaying within the current viewport of the client's device.

The mapping application includes geolocated polygons for neighborhood and city boundaries. The neighborhood and city geolocated polygons aggregate all geofiles located on geolocated polygons within their borders and display them within each neighborhood and city geolocated polygon dialog box. The neighborhood and city dialog boxes also include summaries of the areas, including an overview and themes like history, lifestyle etc. The geolocated polygon dialog boxes for neighborhoods and cities may also include a geofile creation tool 601 (FIG. 4) for geofile creation. There can be a number of ways that users can access neighborhood and city polygon dialog boxes, including, but not limited to, selecting the geolocated polygon on the mapping application.

In one embodiment, each geolocated polygon dialog box on the mapping application will also include property note functionality. Users will access the geolocated polygon dialog box by selecting the geolocated polygon. Once the dialog box is open, the user can opt to create a property note by selecting a second box within the dialog box. Selecting the second dialog box invokes a text field whereby the user may enter notes he or she may have regarding the property that corresponds to the geolocated polygon. Once the property note is created, it is stored in a universal notepad within the user's organization that is accessed through the content management file system on the mapping application. Notes are categorized within the content management file system by property address or date.

Product

Taking the example that a user is working for a real estate investment company and comes across an interesting article about a new development in his/her firm's target market of Los Angeles. The interesting article is one of several articles and presentations about Los Angeles development activity that the user has seen over the last several months. Typically, the user will email these articles around to co-workers and also create a file directory on his/her desktop to save these documents. In addition, the user will use an application to create geofiles of these articles on their corresponding geolocated polygons on a mapping interface. The user's co-workers can now access and comment on these documents on a mapping application 100, helping them contextualize where all the new development is occurring in Los Angeles and collaborate on how this impacts the company's investment thesis going forward.

This document explores the technical feasibility of implementing such file-saving on a map, herein referred to as a geofile. Geofiles are created on geolocated polygons (e.g. property parcels, neighborhoods, cities) on a mapping interface. Geofiles can be created by an individual, a private organization, in-house at Geotiller, or by public organizations (e.g. newspapers, magazines), meaning there could be millions of geofiles on a map from many different organizations. In one embodiment, different viewing permissions are possible, with some geofiles being viewable to only users within a specific organization and other geofiles being potentially viewable to all users and organizations on the mapping application. This is referred to as “public” versus “private” geofiles.

In some embodiments, geofiles may exhibit the following performance characteristics: Private geofiles may be shared via private hyperlinks and commented on by users within the organization that created the file; public geofiles may be shared across the web with a public hyperlink; and unlike geospatial metadata on parcels in other mapping technologies, geofiles reference computer files e.g. pdfs, Microsoft office suite (excel, PowerPoint, word), Argus property DCF files (.sf), etc.

Implementation—Client

In one embodiment, there are three basic approaches for the client to access geofiles. The first approach is through clicking the geolocated polygon, or its associated data marker 603, on which the geofile resides on the mapping application. The client is then taken to the geolocated polygon dialog box whereby they can access the geofile, and any other geofiles associated with that geolocated polygon. The second is through a geofile collection set 301 view of aggregated geofiles residing on the geolocated polygons within the current viewport of the client's device. For example, a client is manually adjusting the map view on their device and ends up residing over Santa Monica, Calif. The client sees several geolocated polygons in the viewport with data markers, meaning one or more geofiles reside at each of these geolocated polygons. The client can select an icon within the mapping application 100 that invokes a geofile collection set 301 that shows the geofiles located within the client's viewport over Santa Monica, Calif. The third is through a client-created file directory tree system located in the mapping system.

Infrastructure—Client

In one embodiment, the infrastructure on the client side is constructed as a pure JavaScript-based web application compatible with all modern web browsers, including leveraging JavaScript frameworks such as AngularJS that enables powerful data binding features used for updating the client.

Infrastructure

In one embodiment, the application is hosted on a virtual machine equipped with the Ubuntu 16 Linux operating system. A NGINX server is used for the HTTP server as it is known for its high performance, stability, rich feature set, simple configuration, and low resource consumption.

Database

In one embodiment, the geospatial database using a PostgreSQL with PostGIS due to its maturity, community, and robust feature set. It is also scalable, as a single PostgreSQL box has official benchmarks of up to 350,000 read operations per second and up to 14,000 write operations per second.

Electronic Apparatus and System

Embodiments may be implemented in digital electronic circuitry, or in computer hardware, firmware, or software, or in combinations of them. Future, embodiments may be implemented using a computer program product (e.g., a computer program tangibly embodied in an information carrier, e.g. in a machine-readable medium for execution by, or to control the operation of, data processing apparatus, e.g. a programmable processor, a computer, or multiple computers).

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In some embodiments, operations may be performed by one or more programmable processors executing a computer program to perform functions by operating on input data and generating output. Method operations can also be performed by, and apparatus of some embodiments may be implemented as, special purpose logic circuitry (e.g., and FPGA or an ASIC).

The computing system may include clients and servers. A client and server are generally remote from each other and typically interact through a communication network. The relationship of client and server arises by virtue of computer programs running on the respective computers and having a client-server relationship to each other. In some embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

What is claimed is:

1. A method comprising:
syncing, by a platform implemented by one or more processors, a plurality of computer files within an existing client data repository on a server to a specified geolocated polygons on a digital mapping interface, wherein the plurality of computer files are at least one of standalone computer files or computer files in a plurality of file directories;
utilizing, by the platform, a geolocated polygon and attribute recommendation tool such that multiple embedded engines including (i) file directory and computer file property parsing to generate address or building name query strings to be processed through a machine learning gazetteer system; and (ii) optical character recognition to locate the address or building name query strings, to be processed through the machine learning gazetteer system, and keywords, processed into n-gram data structures to be cross-referenced against multiple internal or external keyword databases; and
recommending, by the platform, geolocated polygons and geofile attributes, wherein all synced computer files are reviewed by a user and released to a geofile publication engine to be converted into a geofile and displayed on the digital mapping interface.

2. The method of claim 1, wherein the file directory and computer file property parsing engine is configured to search for at least one of addresses, building names, or keywords across file directory names and computer file names to be processed by the machine learning gazetteer system or processed into n-gram data structures.

3. The method of claim 2, wherein the file directory and computer file property parsing engine consists of internal or external building name databases configured to be cross-referenced against potential building names parsed from file directory names or computer file properties to improve the accuracy of the corresponding geolocated polygon recommendations.

4. The method of claim 1, further comprising a location relationship processing engine utilizing optical character recognition cross-referenced against a database of naming conventions and keywords to establish relevant geospatial relationships of related content to recommend geolocated polygons and geofile attributes to the plurality of computer files.

5. The method of claim 1, wherein the optical character recognition engine processes content from the plurality of computer files to n-gram data structures to be cross-referenced against internal or external keyword databases to provide geofile attribute recommendations to the plurality of computer files.

6. A method of claim 5, wherein the n-gram structured data processed by the optical character recognition engine can also be stored in the digital mapping interface to be retrieved by a geofile processing engine at any time in order establish geographic and thematic relationships between a plurality of geofiles on the digital mapping interface.

7. The method of claim 6, further comprising a step of creating an array of geofiles from the plurality of geofiles from different geolocated polygons that share geographic and thematic relationships, wherein the array of geofiles is published to a common storyboard.

8. The method of claim 1, wherein the file directories are configured to be migrated to the geolocated polygon and attribute recommendation tool in order to expedite the geolocated polygon recommendation process.

9. The method of claim 8, wherein a recommendation methodology exists when the plurality of computer files are allocated to file directories ordered by geolocated polygons, wherein the geolocated polygon and attribute recommendation tool is configured to make a universal geolocated polygon recommendation to the plurality of computer files within a specific file directory of the file directories.

10. The method of claim 1, wherein the machine learning gazetteer system is configured to use previous matching experience to recommend a geolocated polygon based on parsed file directory names and computer file properties as well as optical character recognition techniques such that the syncing is more accurate and expedited.

11. The method of claim 1, further comprising a step of the user manually reviewing recommendations from the geolocated polygon and attribute recommendation tool to ensure accuracy prior to releasing a computer file or file directory of a plurality of computer files to the geofile publication engine to be converted to at least one geofile, wherein the at least one geofile is displayed on the digital mapping interface.

12. The method of claim 11, further comprising a step of the user manually adding a geographic location to each of the plurality of computer files if the geolocated polygon and attribute recommendation engine is unable provide recommendations or an accurate recommendation as it relates to each of a plurality of computer files' corresponding geolocated polygon.

13. The method of claim 1, wherein the geolocated polygon comprises a plurality of types including an individual property parcel, a neighborhood, or a city, and wherein the geolocated polygon and attribute recommendation engine may provide a geolocated polygon recommendation of a computer file that may include all of the plurality of types, none of the plurality of types, or any other combination thereof.

14. A method steps comprising:
(a) selecting a geolocated polygon on a mapping interface;
(b) creating at least one geofile by uploading at least one computer file via a geofile creation tool on the geolocated polygon viewer, wherein the at least one file has defined attributes;
(c) sending the at least one geofile to a geofile publication module; and
(d) displaying the at least one geofile on the mapping interface.

15. The method of claim 14, wherein in step (a), the geolocated polygon types include an individual property parcel, a neighborhood and a city.

16. The method of claim 14, wherein in step (b), the defined attributes include, but are not limited to, location, publish date, document file type, and a tag criteria.

17. The method of claim 14, further comprising a step of recommending a geolocated polygon based on the at least one file, wherein the recommendation is processed through a geolocated polygon and attribute recommendation tool, wherein the geolocated polygon and attribute recommendation tool uses an optical character recognition processing engine, a locational relationship processing engine, and a file directory and computer file property parsing engine.
